(19) United States
(12) Patent Application Publication
(10) Pub. No.: US 2010/0152960 A1
(43) Pub. Date: Jun. 17, 2010

(54) ON-LINE VEHICLE MANAGEMENT SYSTEM

(75) Inventors: Chester A. Huber, Grosse Pointe Farms, MI (US); Jeffrey P. Christensen, Clinton Township, MI (US); Michael D. Solomon, Novi, MI (US); Carl J. Hering, Farmington Hills, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS LLC, Detroit, MI (US)

(21) Appl. No.: 12/622,842

(22) Filed: Nov. 20, 2009

Related U.S. Application Data
(60) Provisional application No. 61/138,503, filed on Dec. 17, 2008.

(51) Int. Cl. G06F 7/00; G06F 3/048; G06F 17/00

(52) U.S. Cl. 701/33; 715/843; 715/777; 715/212

(57) ABSTRACT

An on-line vehicle management system includes a vehicle group having a plurality of vehicles and an in-vehicle telematics unit in each vehicle. A call center is in selective operative communication with each telematics unit and an Internet-enabled program. The call center receives vehicle data from each vehicle in response to a predetermined trigger, and stores the received data in a database. The Internet-enabled program includes a Gregorian calendar with spreadsheet functionality. The Internet-enabled program automatically receives at least some of the stored data from the call center, and inputs the received data into predetermined calendar cells. The Internet-enabled program is also configured, in response to a predetermined user request, to i) render the received data accessible to an authorized user associated with the vehicle group, ii) generate reports based on the received data, and iii) at least one of derive or calculate information from the received data.

### CROSS-REFERENCE TO RELATED APPLICATIONS

This application claims the benefit of U.S. Patent Provisional Application Ser. No. 61/138,503, filed Dec. 17, 2008, entitled “On-line Vehicle Management System,” which application is incorporated by reference herein in its entirety.

### TECHNICAL FIELD

The present disclosure relates generally to an on-line vehicle management system.

### BACKGROUND

Mileage may be tracked for vehicles. Such mileage data may be utilized to predict maintenance needs, and thus maintenance related vehicle expenses. Mileage data, in addition to other vehicle usage data, may be particularly useful to business owners that own and operate numerous vehicles. In order to track such mileage and usage date, vehicle performance data is generally used. Vehicle owners/users often rely on their own methods for tracking vehicle performance data. Such methods require the user to manually maintain vehicle performance records, and to manually input such data in order to perform the desired calculations.

### SUMMARY

An on-line vehicle management system includes a vehicle group having a plurality of vehicles and an in-vehicle telematics unit in each vehicle. A call center is in selective operative communication with each telematics unit and an Internet-enabled program. The call center receives vehicle data from each vehicle in response to a predetermined trigger, and stores the received data in a database. The Internet-enabled program includes a Gregorian calendar with spreadsheet functionality. The Internet-enabled program automatically receives at least some of the stored data from the call center, and inputs the received data into predetermined calendar cells. The Internet-enabled program is also configured, in response to a predetermined user request, to i) render the received data accessible to an authorized user associated with the vehicle group, ii) generate reports based on the received data, and iii) at least one of derive or calculate information from the received data.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram of an example of the on-line vehicle management system;

FIG. 2 is a schematic flow diagram depicting an example of a method for collecting data from one or more vehicles in a fleet;

FIG. 3 is an example of a daily report formed via the on-line vehicle management system;

FIG. 4A is an example of a summary page illustrating information included in a sheet associated with the weekly summary tab of the page;

FIG. 4B is the summary page of FIG. 4A illustrating information included in a sheet associated with the monthly summary tab of the page;

FIGS. 5A through 5D illustrate user-defined alerts generated via the on-line vehicle management system;

FIG. 6 is a report illustrating a travel usage log for one vehicle in the fleet;

FIGS. 7 through 10 illustrate different examples of reports generated using the on-line vehicle management system;

FIG. 11 is an example of a diagnostics report generated via the on-line vehicle management system;

FIG. 12 is an example of an oil life report generated via the on-line vehicle management system; and

FIGS. 13 and 14 are graphs respectively illustrating examples of how contacts may be increased and tracked as a result of using the on-line vehicle management system, and of how costs may be decreased and tracked using the on-line vehicle management system.

### DETAILED DESCRIPTION

Examples of the method and system disclosed herein advantageously enable a business owner to manage a fleet of vehicles. The system includes daily, weekly, and monthly presentation means based on a Gregorian calendar with spreadsheet functionality. Data is uploaded to the calendar from a call center which receives the data directly from the vehicle, and reports and other useful data may be calculated and/or generated using the system.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

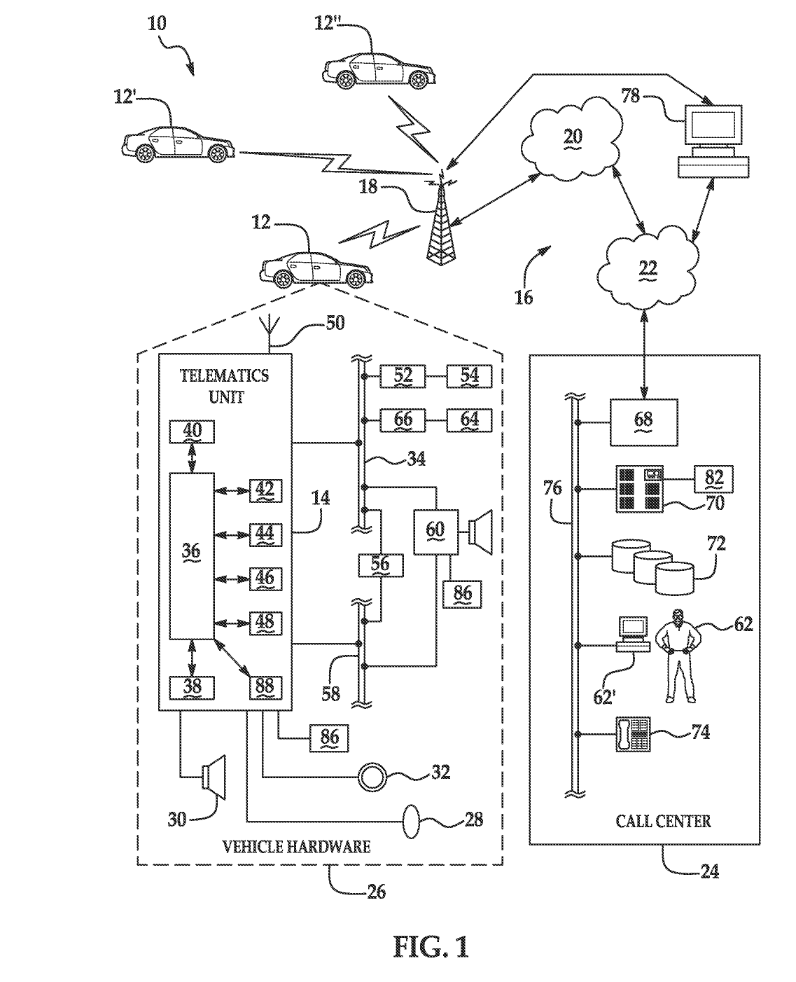

Referring now to FIG. 1, the system 10 includes a fleet of vehicles 12, 12′, 12″ (each of which includes a telematics unit 14), a wireless carrier/communication system 16 (including, but not limited to, one or more cell towers 18, one or more base stations and/or mobile switching centers (MSCs) 20, one or more land networks 22, one or more service providers (not shown)), and one or more call centers 24. In an example, the wireless carrier/communication system 16 is a two-way radio frequency communication system.

The system 10 also includes an Internet-enabled program 78 that is in selective communication with the server 70 (and associated software 82) of the call center 24 (e.g., via wireless carrier/communication system 16 or some other suitable communication system). The Internet-enabled program 78 is supported and hosted by one or more servers (not shown) that are capable of communicating with at least the call center 24, and in some instances, the vehicles 12, 12′, 12″.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicles 12, 12′, 12″ are mobile vehicles, such as a motorcycle, car, truck, recreational vehicle (RV), boat, plane, etc. The vehicles 12, 12′, 12″ may be part of a group or fleet that is operated together under the same ownership and/or management.

The vehicles 12, 12′, 12″ are equipped with suitable hardware and software that enables them to communicate (e.g., transmit and/or receive voice and data communications) over the wireless carrier/communication system 16. It is to be understood that the vehicles 12, 12′, 12″ may also include additional components suitable for use in the telematics unit 14.

Some of the vehicle hardware 26 is shown generally in FIG. 1, including the telematics unit 14 and other components that are operatively connected to the telematics unit 14. While the vehicle hardware 26 is shown as being operatively disposed in vehicle 12, it is to be understood that each vehicle 12′, 12″ has vehicle hardware 26 disposed therein as well. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The telematics unit 14 also includes a vehicle data upload (VDU) system 88, which is configured to receive raw vehicle data from the bus 34, packetize the data, and upload the packetized raw data to the call center 24 (or other external entity) in response to some trigger. In the example shown in FIG. 1, the VDU 88 is operatively connected to the processor 36 of the telematics unit 14, and thus is in communication with the call center 24 via the bus 34 and the wireless communication system 16. The VDU 88 is the telematics unit's central data system that can include a modem, a processor, and an on-board database. The database can be implemented using a separate network attached storage (NAS) device or be located elsewhere, such as in memory 38, as desired. The VDU system 88 has an application program that handles all of the vehicle data upload processing, including communication with the call center 24 and the setting and processing of triggers.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 86, which may be operatively connected to the telematics unit 14 directly, or may be part of the audio component 60. Non-limiting examples of the display 86 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22, and between the Internet-enabled program 78 and the land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 and Internet-enabled program 78 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes one or more switches 68, servers 70 and software 82 associated therewith, databases 72, live and/or automated advisors 62, 62′, as well as a variety of other telecommunication and computer equipment (e.g., a router) 74 that is known to those skilled in the art. These various call center components are coupled to one another via a network connection (e.g., an Ethernet LAN) or bus 76, such as the one (vehicle bus 34) previously described in connection with the vehicle hardware 26.

As shown, the server 70 may be associated with software 82, which supports the Internet-enabled program 78 that is accessible to subscribers via the Internet.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem (not shown) or other piece of equipment for demodulation and further signal processing. The modem preferably includes an encoder, as previously explained, and can be connected to various devices such as the server 70 and database 72. For example, database 72 may be designed to store subscriber profile records, subscriber behavioral patterns, vehicle data, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

It is to be understood that, although a service provider (not shown) may be located at the call center 24, the call center 24 is a separate and distinct entity from the service provider. In an example, the service provider is located remote from the call center 24. A service provider provides the user with telephone and/or Internet services. In an example, the service provider is a wireless carrier (such as, for example, Verizon Wireless®, AT&T®, Sprint®, etc.). It is to be understood that the service provider may interact with the call center 24 to provide service(s) to the user.

The vehicles 12, 12′, 12″ are able to upload vehicle performance data to the call center 24 via the VDU system 88 in conjunction with the wireless communication system 16. Generally, such information is uploaded in response to a particular trigger event within the vehicle 12, 12′, 12″. One or more trigger events are programmed into the telematics unit 14, such that when a particular event occurs, the vehicle data upload system 88 of the telematics unit 14 knows to transmit certain data. The triggers may be set by the call center 24 at the time of manufacturing using a default value (e.g., once every thirty days, in response to a vehicle ON or OFF event, etc.), may be initiated by the user on demand, or may be initiated by the call center 24 on demand.

In one example, if a problem occurs within a vehicle 12, a subscriber may push a button 32 in the vehicle cabin and request a diagnostic analysis by an advisor 62 at the call center 24. The advisor 62 may then initiate a vehicle data upload by issuing a trigger or command to the telematics unit 14 to upload diagnostic data. The telematics unit 14 receives the trigger in a message from the call center 24 which instructs processor 36 to monitor the vehicle bus 34 for diagnostic and/or component status messages. The message received from the call center 24 may contain a list of bus messages to monitor. Once the bus messages are monitored, either by a query from the telematics unit 14 or by detection of unsolicited messages sent by the vehicle modules, the telematics unit 14 caches the diagnostic and/or component status messages in memory 38. The telematics unit 14 will then packetize the collected vehicle data and send the vehicle stats to the call center 24.

In another example, the telematics unit 14 may be programmed initially with a trigger to collect and upload diagnostic and/or vehicle component data once a month in order for a diagnostic report to be generated and sent to the call center 24, and/or a subscriber or vehicle owner.

In still another example, the call center 24 may arbitrarily issue a trigger to one or more vehicles 12 for vehicle data upload either by a human advisor 62 or automaton 62′.

When the event takes place, data associated with that event is uploaded to the call center 24 and is stored in the database 72, for example, in the personal profile associated with that particular vehicle 12, 12′, 12″.

As mentioned above, the trigger may be independent of the vehicle 12 (i.e., a pre-set time-based trigger, on demand request triggers from the user or call center 24) or may be dependent upon the vehicle 12 (e.g., an ignition trigger, a maintenance trigger, such as mileage, oil life, etc.). As non-limiting examples, data upload triggers include an ignition ON event and an ignition OFF event. It is to be understood that particular data is associated with such events. For example, an ignition ON event may be associated with an aged GPS indication, the date, the time, an odometer reading, and the fuel level, while an ignition OFF event may be associated with the date, the time and the engine run time or the date, the time, an odometer reading and the fuel level. It is to be understood that data not associated with a particular data upload trigger event will not be uploaded in response to that particular data upload trigger event. Furthermore, during the uploading of the data, there may be a one-time data upload for the fuel capacity of the vehicle fuel tank. This may be programmed to occur during the first upload event or at any other desirable time.

The data associated with a particular trigger may be the result of default programming or may be configured via the call center 24 (e.g., in response to a group/fleet manager's request). Generally, the telematics unit 14 is programmed with default values before the unit 14 is installed in a vehicle 12. However, such default values are configurable and may be subsequently altered. For example, the call center 24 may send a new list of diagnostic trouble codes for the telematics unit 14 to monitor and associated such codes with triggers for data upload.

In response to the data upload trigger event, vehicle data uploading will be initiated and the telematics unit 14 will send data to the call center 24 in groups based on the type of data stored for each event. Non-limiting examples of such groups include GPS data packets, timestamp/odometer packets and Abstract Diagnostic Access (ADA) packets. The GPS data packet may include latitude, longitude, aged data indicator, speed, heading/travel direction, and Dilution of Precision (DOP). When the telematics unit 14 is configured for GPS data, this packet will be transmitted to the call center 24. However, it is to be understood that the telematics unit 14 will zero fill any values for which it is not configured. The timestamp/odometer data packet may include the date, time and odometer reading at the time of the trigger event. When the telematics unit 14 is configured for timestamp and odometer data, this packet will be transmitted to the call center 24. However, it is again to be understood that the telematics unit 14 will zero fill any values for which it is not configured. Generally, the ADA data packet may include the serial data commands (e.g., a Class 2 Pass Through (C2PT) command table for ADA network type commands). If the telematics unit 14 is not configured for serial data, this packet will not be transmitted by the telematics unit 14.

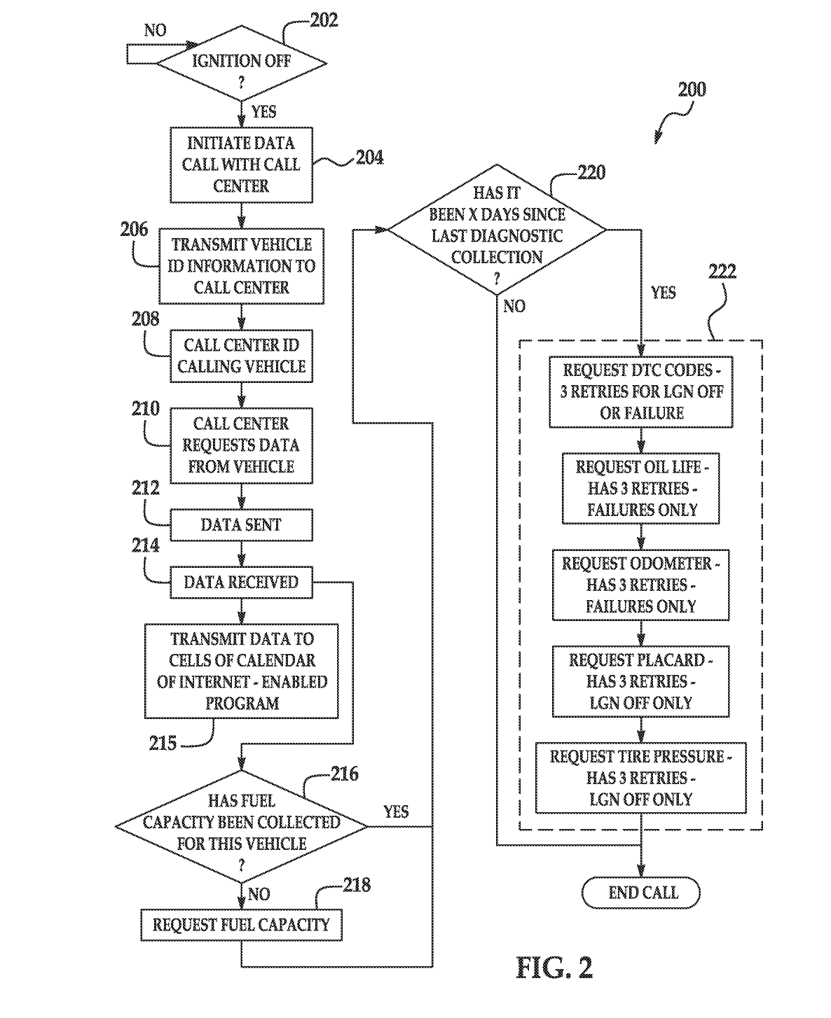

A non-limiting example of a method for uploading the vehicle data in response to a trigger event is shown as reference numeral 200 in FIG. 2. In this example, the ignition OFF is the trigger event, as shown at reference numeral 202. When the ignition OFF event is recognized, the telematics unit 14 (as known as a vehicle control processor, VCP) initiates communication with the call center 24, as shown at reference numeral 204. Generally, a packet session is established in which data may be gathered and packetized at the vehicle data upload system 88. Once communication is established, the telematics unit 14 transmits vehicle identifying data (VID), such as the vehicle VIN, a mobile dialing number, etc., so that the call center 24 (i.e., the back-office) identifies the calling vehicle 12, 12′, 12″ (see reference numerals 206 and 208).

Once the vehicle 12, 12′, 12″ is identified, the call center 24 requests that any data associated with the particular trigger event be uploaded to the call center 24, as shown at reference numeral 210. It is to be understood that once the data call is established, the vehicle data upload system 88 may push the data corresponding to the trigger without the call center 24 making such a request. For example, data may also be pushed from the vehicle 12 to the call center 24 periodically or on demand by a vehicle user. Once the data is sent (reference numeral 212) and successfully received (reference numeral 214), the call center 24 may store such data in the vehicle's profile in the database 72. At the call center 24, the received data may be conditioned and sent to a vehicle owner via email or other means. The data may also be used for analysis for a singular or class or vehicles.

In one example, the call center 24 transmits some or all of the data to the calendar of the Internet-enabled program 78, as shown at reference numeral 215 and as discussed further herein in reference to the other figures.

As shown in FIG. 2, after receiving the data associated with the trigger, the call center 24 may then also determine whether the fuel capacity has been collected for the vehicle 12, 12′, 12″ (reference numeral 216). This routine may be accomplished to update other data that may not be associated with the data sent in response to the trigger. If the fuel capacity has not yet been collected, the call center 24 transmits a request for the fuel capacity to the telematics unit 14 (reference numeral 218), and the telematics unit 14 responds by transmitting such data.

The telematics unit 14 then determines how long it has been since the last vehicle diagnostic data collection, as shown at reference numeral 220. If the number of days since diagnostic data collection has occurred within the vehicle 12, 12′, 12″ is over a predetermined threshold (e.g., 7 or any other number of days), the vehicle 12, 12′, 12″ will perform a number of diagnostics, as shown at reference numeral 222. Diagnostics include gathering diagnostic trouble codes (DTC codes), oil life data, odometer data, placard data, and/or tire pressure data. As shown in FIG. 2, in the event of failing to obtain then-current data, the diagnostics may be set to retry a predetermined number of times prior to logging out and/or reporting failure. It is to be understood that one or more of these data types may have been collected and transmitted in response to the trigger. As such, running a diagnostic data collection will gather more up-to-data data. The updated data will generally be transmitted in response to the next trigger event, if such data is associated with the recognized trigger. Examples of triggering the collection of vehicle data and of triggering the transmission of notifications of such vehicle data are further described in U.S. Patent Publication No. 2007/0173992, filed Dec. 29, 2006, incorporated by reference herein in its entirety.

In this example, it may be desirable to sort the uploaded vehicle data by VIN, with the odometer and timestamp data in ascending order when the Ignition OFF data is listed prior to the Ignition ON data. Such a sort will ensure the proper trip pairing of an ignition OFF event with an ignition ON event.

It is to be understood that data may be uploaded to the call center 24 at predetermined intervals, for example, every minute when the vehicle is in an ON state. This enables the data in the call center 24 to be relatively current, even when a predetermined trigger is not recognized.

Once data is uploaded to the call center 24, it may be processed at the call center 24 to determine miles driven (at a particular time, on a particular day, etc.), miles per gallon, trip dates and times, when fuel filling events have occurred, when charging events have occurred, and other like information. Such data is then transmitted to the Internet-enabled program 78 via the wireless communication system 16. The processor 70 is configured with algorithms and software routines capable of manipulating the data received from the vehicle 12, 12′, 12″, and then populating appropriate fields/cells of the Internet-enabled program 78. The data incorporated into the Internet-enabled program 78 may still be stored in the database 72. The data transmitted from the call center 24 to the Internet-enabled program 78 may be in response to a request from a user of the Internet-enabled program 78 and/or periodically (e.g., at the end of every day or week), and as a result of the call center 24 pushing such data and/or as a result of a software routine of the Internet-enabled program 78 pulling such data.

As previously mentioned, the Internet-enabled program 78 is a Gregorian calendar that organizes the received vehicle data. Generally, the program 78 is useful for a business owner/operator who has a number of vehicles 12, 12′, 12″ (i.e., a group or fleet) in operation in their ordinary course of business. The program 78 allows the data from each of the vehicles 12, 12′, 12″ in the fleet to be input and organized in the form of reports for an individual vehicle 12 or 12′ or 12″, reports consolidating data for two or more of the vehicles 12, 12′, 12″, and/or reports comparing data for two or more of the vehicles 12, 12′, 12″. The presentation of the data may be defined by the user, and thus may be customized per the user's needs and/or preferences.

Generally, the manager and/or owner (or other authorized person) of a fleet of vehicles 12, 12′, 12″ signs up to utilize the Internet-enabled program 78. Upon registering, the user is given an initial password and login ID, both of which may be customized by the user after the initial registration process is complete. An account is set up for the user, which includes the company name associated with the account, a fleet account number, an executive or other person associated with the account, contact information, billing information, etc. The subscriber can enroll via one of several methods. As one method, the subscriber can enroll through a website associated with the Internet-enabled program 78, which may or may not be part of a more comprehensive vehicle services website. A second method for enrolling includes placing a voice call to a call center live advisor 62. The live advisor 62 has computer access to the subscriber's account information for the purpose of carrying out the enrollment.

The website of the Internet-enabled program 78 may include a homepage (not shown) including enrollment boxes, and login and ID boxes that enable a user to access his/her account. The homepage may also include convenient drop-down options for the user, for easy access to a plurality of reports (examples of which are described hereinbelow). The Internet-enabled program 78 is available 24 hours a day and 7 seven days a week, thus allowing a user flexibility in managing the vehicle fleet.

Upon signing up, the user registers the vehicles 12, 12′, 12″ in the fleet (including vehicle ID, make and model, region in which vehicle is used, etc.), any other user's authorized to access the account (including their name, user ID, etc.), and/or designates any desirable parameters for the calendar as a whole and/or for any particular vehicle 12, 12′, 12″ in the fleet. For example, if the work week of a particular vehicle 12 begins on Saturday, such a parameter may be set in the calendar associated with that vehicle 12. Other suitable parameters include designating groups (name of group, vehicles in a group, group manager, etc.), designating off hours (i.e., non-regular working hours) and regular work hours for an individual or group, designating goals for an individual or group, designating data presentation configurations (e.g., number of decimal places used, intervals for time-related data, units for data, classifications for particular events (e.g., business trip during off hours, personal trip, etc.), or the like. It is to be understood that the parameters may be changed upon initiating the account, or at any time thereafter. If such parameters are adjusted after data has already been collected and input into the program 78, the previously stored data will not be affected by such changes.

It is to be understood that different members associated with an account of the Internet-enabled program 78 may be given different levels of access to information upon logging in. For example, a particular business having an Internet-enabled program 78 account may desire that a vehicle manager (e.g., in charge of vehicle diagnostics and alerts), a driver manager (e.g., in charge of personal, and thus driver behavior and driver alerts), one or more drivers (e.g., in charge of product sales, delivery, or the like), and an administrator (e.g., in charge of managing the data, providing access, etc.) all have access to the account. However, it may be desirable that each employee has a different level of access to the information within the account. For example, it may be desirable that a driver only have access to his/her personal vehicle reports, and no access to other vehicle reports. Such access levels may be designated when a particular user is added to the account. Such access levels may be determined by a manager and/or an administrator, and set within the program 78.

When a user is allowed access to a particular calendar, he/she will generally have the ability to change particular designations within the reports. For example, a driver will be able to change the classification of a trip from business to personal. However, because the data inputted into the program 78 comes from the call center database 72, such data may not be manipulated by the user. This ensures that the data is seen as it was collected and transmitted by the telematics unit 14.

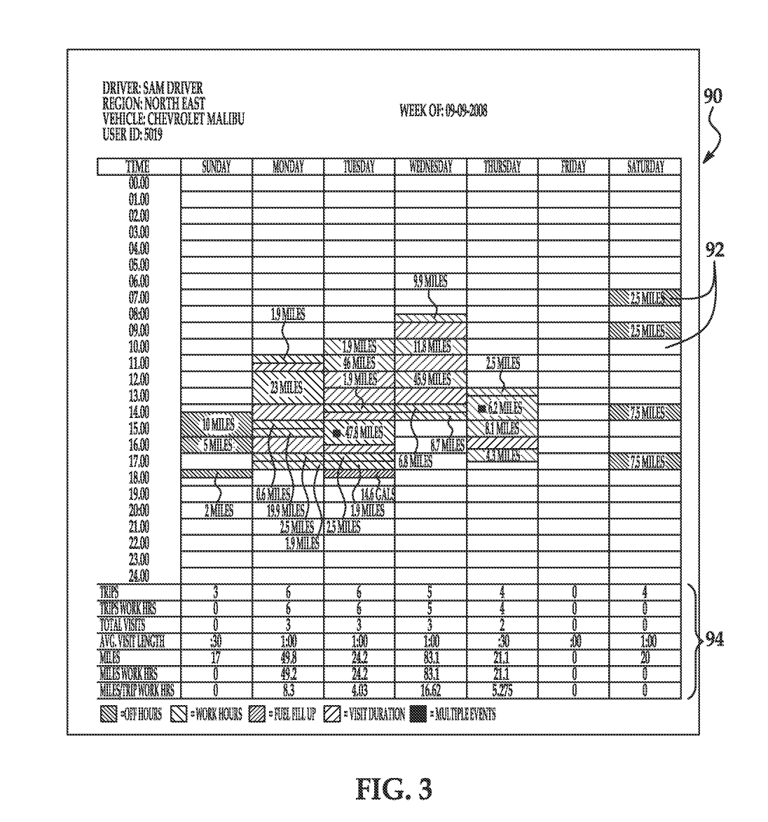

Referring now to FIG. 3, one example of a report 90 generated by the system 10 is depicted. As previously mentioned, the calendar parameters (e.g., beginning of week, time intervals, etc.) are designated by the user, and the data inserted into the appropriate cells 92, 94 of the calendar is obtained from the database 72. This report 90 is for an individual driver for the week of Sep. 9, 2008. The report 90 includes daily details (broken down into any desirable time frame (e.g., 10 minute intervals, 15 minute intervals, etc.) and summaries (see, e.g., cells 94). The Gregorian calendar with spreadsheet functionality includes columns corresponding to the days of the week, and rows corresponding to time intervals throughout each day.

In one example, when generating the report 90, the program 78 is configured to retrieve the appropriate data from the call center database 72 and to auto-fill the appropriate cells 90, 92 with such data. In another example, when generating the report 90, the call center 24 is configured to receive the request of the program user, and will push the appropriate data from the call center database 72 to auto-fill the appropriate cells 92, 94 with such data.

As shown in grey-scale in FIG. 3, the cells/fields 92 may be color- or pattern-coded, and such colors or patterns may be designated by the user. The various colors or patterns may be associated with particular events, such as off hours, work hours, fuel filling events (which may include number of gallons added), charging events (which may include amount electric battery is charged) visit durations (i.e., on regular work days, time at which the driver is visiting a client), multiple events, or the like. In some instances, the color or pattern coding may be used so that a user can easily identify events that may require action. In FIG. 3, a pattern of closely spaced angled lines extending downward toward the right is associated with off hours, a pattern of spread out angled lines extending downward toward the right is associated with work hours, a pattern of closely spaced angled lines extending downward toward the left is associated with fueling events, a pattern of spread out angled lines extending downward toward the left is associated with visit durations, and black squares are associated with multiple events occurring within the same time intervals. The user may select colors when registering with the program 78 or at any time thereafter, and may change the colors as desirable. It is to be understood that color and/or pattern designations may be made by those users having suitable access, for example, a driver may not have access to designate or reassign colors with events.

Some of the cells 92 are filled with raw vehicle data, such as gallons purchased during a fuel filling event or mileage for a particular time interval. Other raw data includes oil life, odometer readings, tire pressure, location, battery voltage, flex fuel usage, fluid levels, and/or speed. Other cells 92 are color- and/or pattern-coded and do not necessarily contain raw vehicle data therein. In these other cells, the color- and/or pattern-coding itself is indicative of data that is derived from raw vehicle data, such as visit durations (time between a vehicle OFF event and a vehicle ON event), engine run time (time between a vehicle ON event and a vehicle OFF event), vehicle maintenance data (e.g., replace air filter, rotate tires, replace brakes, etc.). In FIG. 3, the pattern-coded cells including spread out angled lines extending downward toward the left indicate that the driver was at a client visit. Still other information may be categorized as being vehicle-related data, such as, for example, telematics service subscription information, lease expiration date, hybrid information, recall campaign information, Internet-enabled program subscription information, or other vehicle-related information (e.g., color, make, model, etc.). This other information may not be available from the vehicle 12, 12′, 12″ itself, but rather may be available from the call center 24 or from the program 78.

The example shown in FIG. 3 is also configured with result cells 94, which are configured to calculate totals or averages for the data in the report 90. In the example shown in FIG. 3, the result cells 94 include total number of trips for a particular day, total number of trips during regular work hours, total visits, average lengths of visits in a day, total miles traveled for a day, total miles traveled within regular work hours, average miles per trip during work hours. The calculated results may be useful for determining time spent in the vehicle and with clients in order to determine better methods for servicing clients, determining reward programs, increasing efficiency, evaluating mileage, or the like. As one example, the report 90 may be used to determine a driver's normal hours in order to maximize his/her efficiency. Evaluation of the total mileage may lead to the development of cost control programs (e.g., rerouting drivers, etc.). Such results will also enable supervisors and/or managers to review the time spent in the vehicle during non-regular work hours. As such, the report 90 may be used to determine how often a driver is making client contact on the weekends, and then may be used to develop incentive or reward programs to encourage such behavior.

Similarly, the data (both raw and derived) in the report 90 may be associated with electric or hybrid vehicles. When the fleet includes fuel-alternative vehicles, the data collected and derived may pertain to charging events, time of an electric trip, mileage when the vehicle is run in an electric mode, gas mileage versus electric mileage, etc. The data input into the program 78 may be color- or pattern-coded as described hereinabove. In a non-limiting example, one color may be selected for purely electric trips, and the colors may vary depending upon the amount of gasoline consumed. The data obtained may be used to determine, for example, optimal charging times for the region for the particular vehicle 12, 12′, 12″ within the fleet (e.g., an example of increasing efficiency), and charging schedules based on an individual's driving pattern and the topology of the routes drive.

The program 78 may be configured with algorithms and/or software routines to calculate fuel efficiency and/or charge efficiency in the daily/weekly reports. If a particular driver uses more than one vehicle in a particular week, the daily/weekly report may indicate as such, and thus fuel efficiency and/or charge efficiency will not be calculated for that week.

While the reports 90 show a driver being associated with a single vehicle 12, 12′, or 12″, it is to be understood that the vehicle 12, 12′, 12″ may be assigned to two or more different drivers having different regular work hours. Reports 90 may be generated for the particular driver and/or for the vehicle 12, 12′, 12″. When run for the vehicle 12, 12′, 12″, the report 90 will indicate both drivers and all of the data, regardless of who was operating the vehicle 12, 12′, 12″. When a report 90 includes data for a single vehicle 12, 12′, 12″, but multiple drivers, the work hours for one driver may be color-coded differently than the work hours for the other driver.

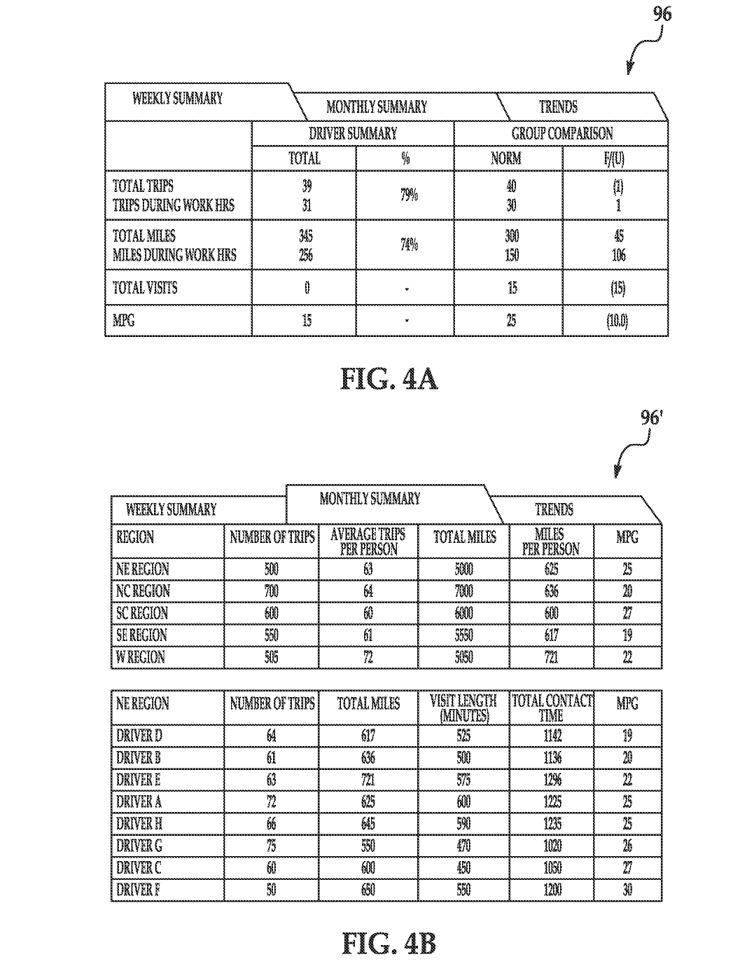

FIGS. 4A and 4B illustrate different sections of a summary page 96, 96′. The summarized data in the summary page 96, 96′ is extrapolated from the data in individual reports 90. In some instances the summary page 96, 96′ is based on a single vehicle 12, 12′ or 12″, and in other instances, the summary page 96, 96′ is based on all the vehicles 12, 12′, 12″ in a particular group or all the vehicles 12, 12′, 12″ in a fleet or group. In the examples of FIG. 4A, one driver's data is summarized as well as the group's data. This enables a user (e.g., the group manager) to compare a particular driver with averages of the group to which he/she belong. Such a comparison may be used to generate a median for the group, and then reward and/or encourage one or more drivers within a group depending upon where their performance is relative to the median. While the miles per gallon data is shown in FIG. 4A, it is to be understood that miles per charge data may also or alternatively be shown, depending upon the vehicles 12, 12′, 12″ in the fleet.

In the example of FIG. 4B, the groups are divided by regions, and all of the data for the drivers in the NE region is shown. It is to be understood that parameters may be manipulated to show other individual data within a particular region.

The comparisons that may be performed using the summary page 96, 96′ may be particularly suitable to determine which driver within a group or which region, for example, consumes the most gas, and which driver within a group or which region operates in the most energy efficient manner. It is to be understood that such data may be useful for generating vehicle recommendations based on individual and/or regional driving patterns. Furthermore, regional data may also be particularly useful for reconciling differences between gas and electric data due to geographic regions, charging rates, and/or driving behavior.

As shown in both FIGS. 4A and 4B, the summary page 96, 96′ may include a weekly summary tab, a monthly summary tab, and/or a trends tab. Such tabs may be designated by the user, and may depend, at least in part, on the review that is desired. While not illustrated, the trend tab may include trends of the group and/or of an individual.

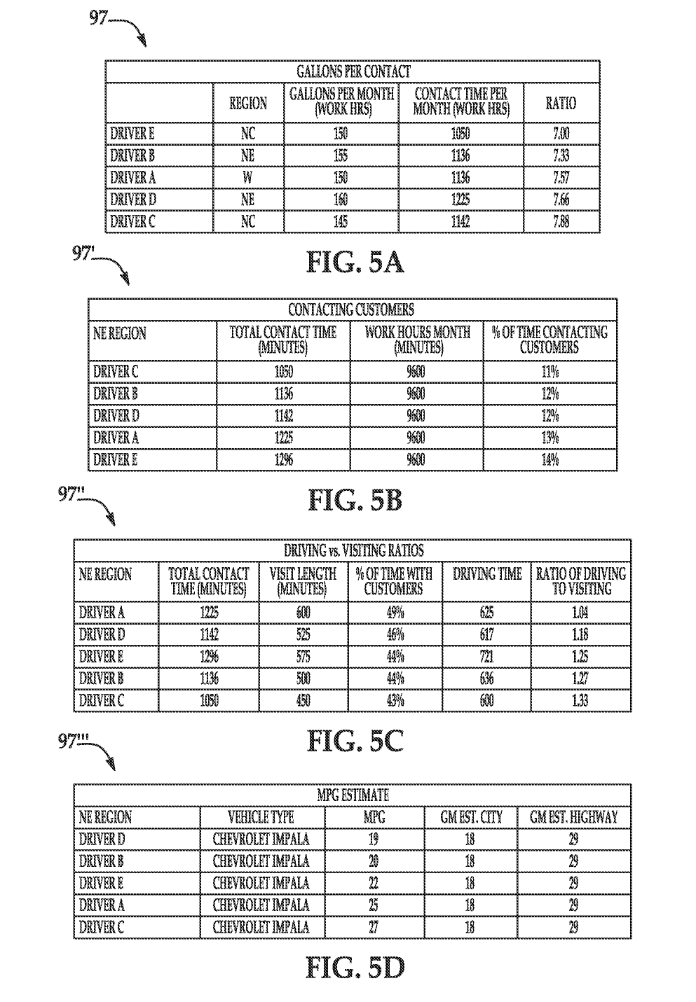

The Internet-enabled program 78 is also able to generate user-defined alerts 97, 97′, 97″, 97′″. Examples of such alerts 97, 97′, 97″, 97′″ are shown in FIGS. 5A through 5D. Non-limiting examples of such alerts 97, 97′, 97″, 97′″ include gallons per contact alerts or charge per contact alerts 97 (FIG. 5A), hours contacting customers alerts 97′ (FIG. 5B), driving vs. visiting alerts 97″ (FIG. 5C), and miles/gallon alerts or miles/charge alerts 97′″ (FIG. 5D). Other examples of such alerts 97, 97′, 97″, 97′″ include, but are not limited to tire pressure monitoring (TPM) alerts, oil life alerts, odometer exceed alerts, recall campaigns (i.e., an alert is sent in response to a recall notice received from a manufacturer), and/or other mileage-based alerts. The alerts 97, 97′, 97″, 97′″ may be customized by an authorized user to include any desirable data. The user may select, for example, that an alert 97, 97′, 97″, 97′″ be transmitted to him/her on a monthly basis, where such alert 97, 97′, 97″, 97′″ includes particular drivers, the region in which they work, the gallons used in that month, the contact time in that month, and the ratio of gallons to contact time. Once set up, the alert 97, 97′, 97″, 97′″ is transmitted to designated recipient(s) at a designated time via email, text or SMS messaging, or the like. The content of the alerts 97, 97′, 97″, 97′″ may vary, depending on the information access level the user has. For example, a driver may be able to set his/her driver behavior alerts (e.g., oil life, mileage, etc.), while a manager may be able to review any alerts the driver receives (whether set by the driver or not).

The content of the alerts 97, 97′, 97″, 97′″ may be assessed to increase the efficiency of the driver and/or group. For example, in the alert 97 of FIG. 5A, fuel and/or charge data may be assessed in an effort control the amount of fuel or charge used by drivers when making client contact. Similarly in FIG. 5B, the amount of time that driver's are spending with clients may be assessed to determine if changes should be made in regard to contact hours. Assessing alerts 97″, 97′″ similar to those shown in FIGS. 5C and 5D may also be used to set benchmarks, for example, relating to total mileage in a week, total client time versus total driving time, etc. In still another example, the data in the alert 97′″ shown in FIG. 5D may be assessed to determine methods for obtaining greater efficiency and profitability.

Vehicle alerts 97, 97′, 97″, 97′″ may be revised and/or cancelled at any time by an authorized user.

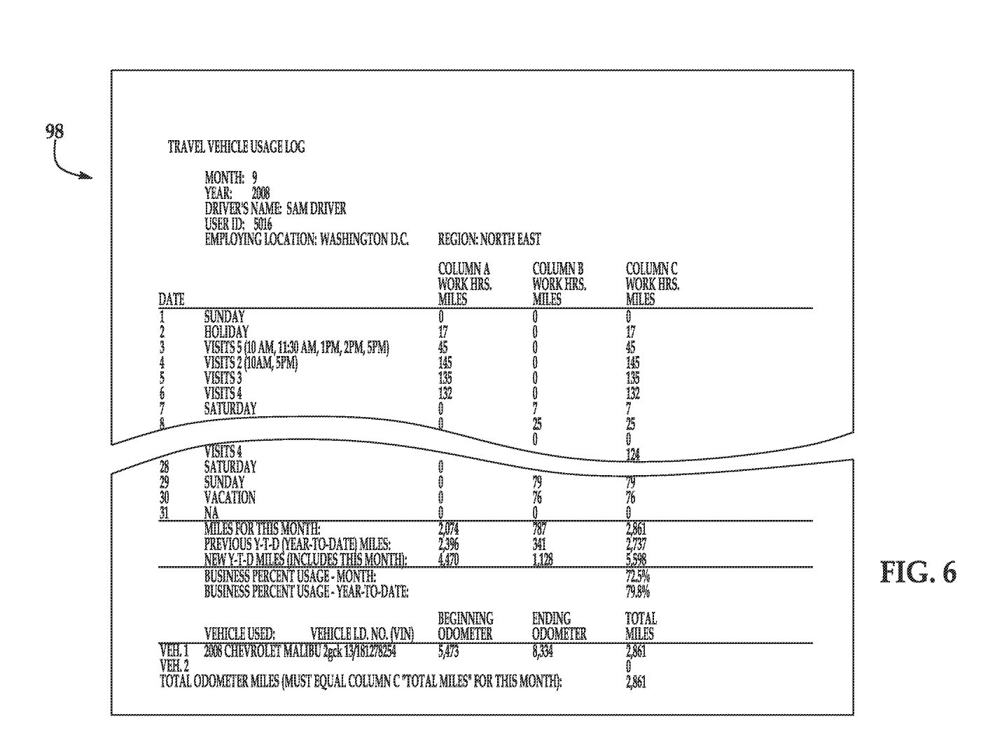

Referring now to FIG. 6, the program 78 is also configured to generate travel vehicle usage logs 98. Generally, such reports 98 are centered around one particular driver's activity. As shown in FIG. 6, the travel vehicle usage log is a mileage summary for a particular vehicle 12, 12′, 12″ for a particular time period. The time period may be revised prior to running the report 98. The automated mileage log eliminates the need for the driver to manually calculate his/her mileage. This type of report 98 reduces paperwork for each individual driver and also eliminates manual calculation errors.

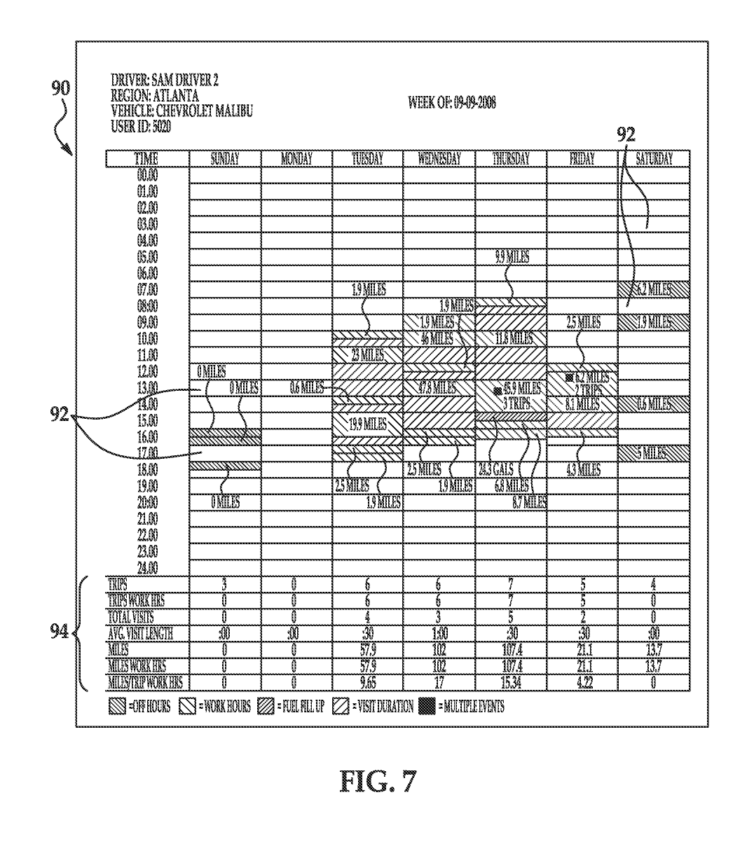

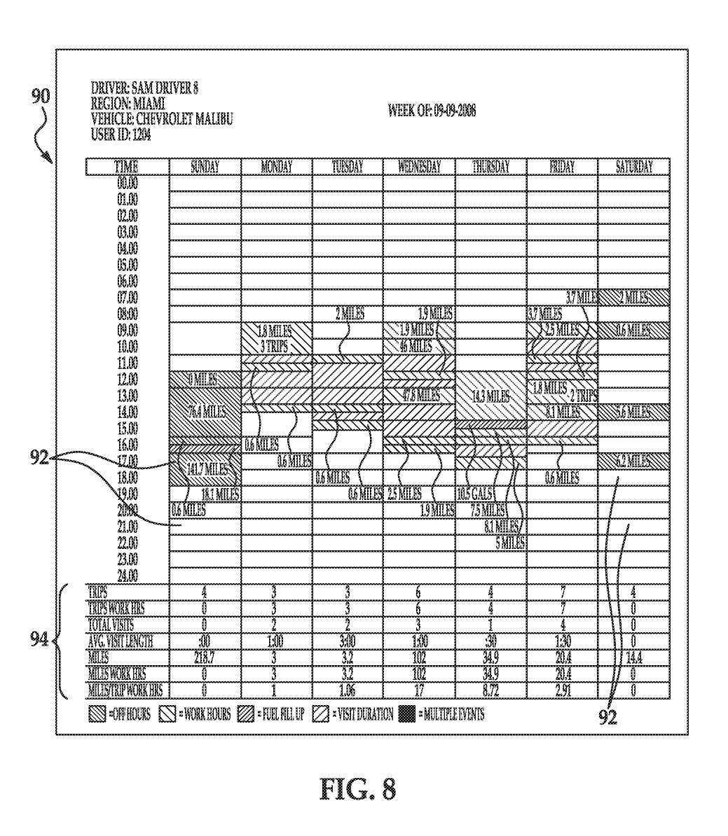

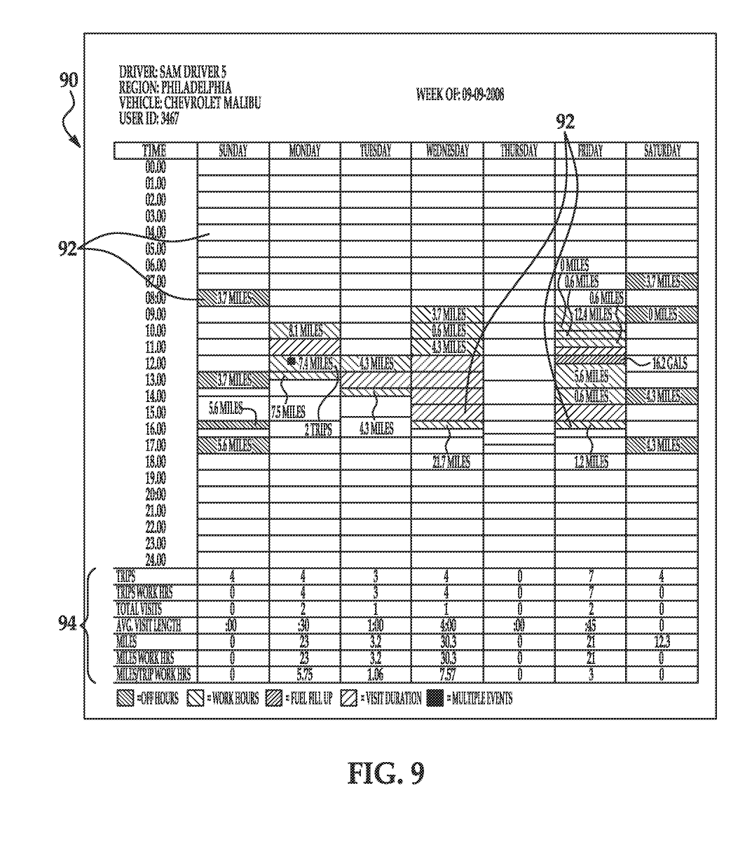

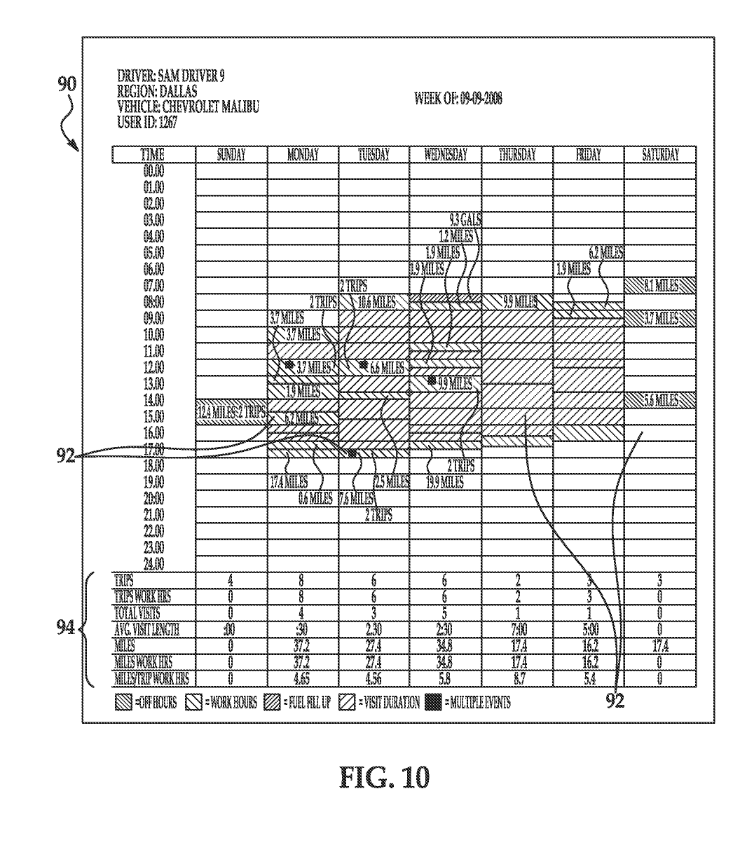

FIGS. 7 through 10 illustrate various reports 90 generated for different drivers within the same week. The mileage and visits are recorded for each work day, as well as any mileage for non-work days. Such reports 90 illustrate the work week, the time intervals, and the data uploaded from the database 72 via the call center 24 for a particular driver and vehicle. Each report 90 also included desirable result cells 94, which total or average the data within the spreadsheet. It is to be understood that such reports 90 may be generated on-demand by a user of the Internet-enabled program 78, or the program 78 may be configured to automatically generate such reports 90 at a certain time.

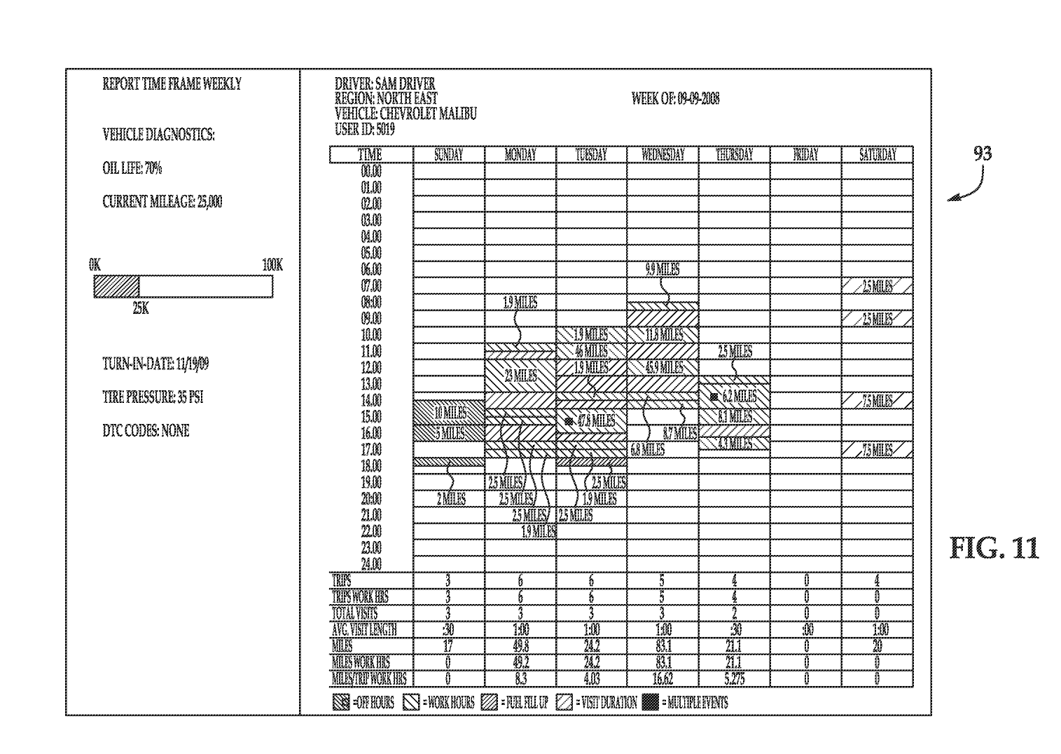

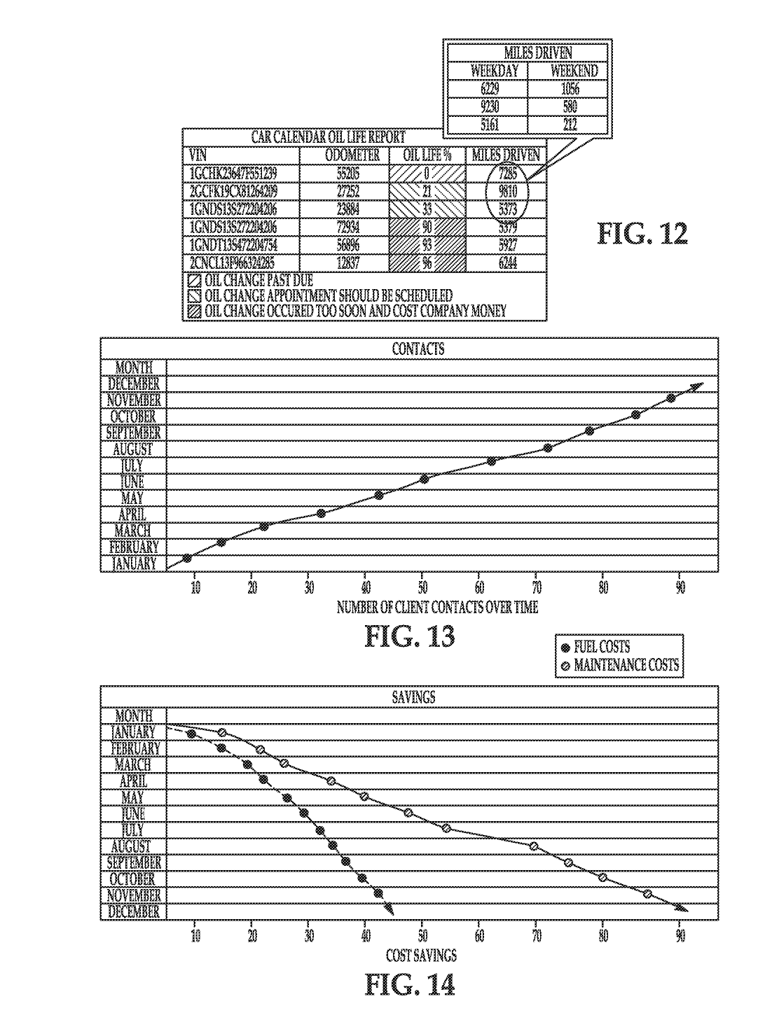

FIGS. 11 and 12 illustrate still two more examples of reports that may be generated using the Internet-enabled program 78. FIG. 11 illustrates a vehicle diagnostics report 93 which includes the color-coded cells containing data and/or identifying a particular event for the user. As shown, the report is a weekly report. The report 93 may be a monthly report, semi-annual report, annual report, or the like. This report illustrates the data from a vehicle diagnostic data packet, as described in reference to FIG. 2. Examples of other reports that may be generated include diagnostics on key operating systems, recall reports, etc. FIG. 12 illustrates an example of another specific report 95 that may be generated. This is an oil life report for multiple vehicles. This type of report enables one to readily deduce which vehicles in the fleet are in need of service or are over-serviced. Other particular reports may be generated in which other vehicle information may be selected and data associated therewith may be displayed in an organized manner. As another non-limiting example, mileage reports may be generated for multiple vehicles 12, 12′, 12″.

The graphs in FIGS. 13 and 14 illustrate how the Internet-enabled program 78 disclosed herein may be used to keep track of performance and cost over time (e.g., keeping track of an increased client contacts (FIG. 13) and decreased costs (FIG. 14) associated with running the particular business). These and other similar graphs may be created using the data in the reports 90.

In any of the examples disclosed herein, the report 90 (or the summary reports 96, 96′) may have a default state, which may be overridden by an authorized user. For example, the default state may be set to the most recently generated report or the previous week's report, and when a user logs into the program 78, this default report will be shown to the user. The default state may be changed if the user has authorization to do so.

Furthermore, in any of the examples disclosed herein, when a user has authorization to do so, he/she may redesign the report to include more or less data (e.g., select new result fields, select a particular summary or comparison to be generated, etc.), as is desirable. As a non-limiting example, a fleet manager may have the capability of redesigning the report to include all or a select few of the groups within the fleet, while a group manager may only have the capability to redesign the report to include his/her group, and any drivers within his/her group. As such, the program 78 will disable the drill down functionality if the particular logged in user does not have access to other levels of information. Authorized users may also search through previously generated reports. For example, a manager may run a query for a list of vehicles having the most number of alerts transmitted thereto, for groups having the most severe alerts transmitted thereto, or other desirable information. Authorized users may also add, delete or otherwise modify groups, drivers, vehicles 12, 12′, 12″, and/or details/information associated therewith at any time.

Still further, when data is not available for a particular cell, the phrase “N/A” or some other like phrase may be inserted into the cell. Such cells may also simply be left blank, which will indicate to the user that data was not available.

All of the various reports disclosed herein have printer-friendly capabilities.

While several examples have been described in detail, it will be apparent to those skilled in the art that the disclosed examples may be modified. Therefore, the foregoing description is to be considered exemplary rather than limiting.

1. An on-line vehicle management system, comprising:
a plurality of vehicles, each vehicle being equipped with an in-vehicle telematics unit and being part of a vehicle group;
a call center in selective operative communication with each of the in-vehicle telematics units, the call center configured to i) receive vehicle data from each of the plurality of vehicles in response to a predetermined trigger, and ii) store the received vehicle data for each of the plurality of vehicles in a database; and
an Internet-enabled program in selective communication with the call center, the Internet-enabled program including a Gregorian calendar with spreadsheet functionality, the Internet-enabled program configured to automatically receive at least some of the stored vehicle data from the call center and input the received data into predetermined cells of the Gregorian calendar, and the Internet-enabled program also configured, in response to a predetermined user request, to i) render the received vehicle data accessible to an authorized user associated with the vehicle group, ii) generate reports based on the received vehicle data, and iii) at least one of derive or calculate information from the received vehicle data.

2. The on-line vehicle management system as defined in claim 1 wherein the call center is configured with a computer system that pushes the stored data to the Internet-enabled program periodically or upon a request made using the Internet-enabled program.

3. The on-line vehicle management system as defined in claim 1 wherein the Internet-enabled program is configured with a software routine that pulls the stored data from the call center periodically or upon a request made using the Internet-enabled program.

4. The on-line vehicle management system as defined in claim 1, further comprising a business entity that owns the vehicle group.

5. The on-line vehicle management system as defined in claim 1 wherein the vehicle data is selected from miles driven for a trip, miles per gallon for a trip, trip date, trip time, fuel refill event time, fuel refill event date, amount of fuel added at a refill event, charging event time, charging event date, or combinations thereof.

6. A vehicle management Internet-enabled program, comprising:
a report page having at least one of daily, weekly, and monthly presentation means based on a Gregorian calendar with spreadsheet functionality, the report page including:
first cells configured to be automatically filled with predetermined vehicle data transmitted from a call center in operative communication with the Internet-enabled program, the call center also being in selective operative communication with a plurality of vehicles in a vehicle group, wherein the predetermined vehicle data is raw vehicle data;
color-coding for at least some of the first cells, wherein each color for the color-coding is associated with a particular event;
second cells configured to be color-coded to correspond with data derived from the raw vehicle data; and
result cells configured to calculate at least one of totals or averages for at least one of the predetermined vehicle data and the derived data automatically filled in the first and second cells.

7. The vehicle management Internet-enabled program as defined in claim 6 wherein the raw vehicle data is selected from gallons purchased during a fuel filling event, mileage, charge purchased during a charging event, oil life, odometer readings, tire pressure, location, battery voltage, flex fuel usage, fluid levels, or speed.

8. The vehicle management Internet-enabled program as defined in claim 6 wherein the derived data include visit durations.

9. The vehicle management Internet-enabled program as defined in claim 6, further comprising a homepage including drop down options associated with sales managing or fleet managing the vehicle group.

10. The vehicle management Internet-enabled program as defined in claim 6, further comprising a summary page including:
a weekly summary report tab;
a monthly summary report tab; and
a trend tab;
wherein data in each of the summary report tabs is generated from the predetermined vehicle data and the derived data in a plurality of the reports, and wherein each of the plurality of the reports is associated with one vehicle in the vehicle group.

11. The vehicle management Internet-enabled program as defined in claim 6, further comprising a summary page including:
a weekly summary report tab;
a monthly summary report tab; and
a trend tab;
wherein data in each of the summary report tabs is generated from the predetermined vehicle data and the derived data in a plurality of the reports, and wherein at least some of the plurality of the reports are associated with different vehicles in the vehicle group.

12. The vehicle management Internet-enabled program as defined in claim 6 wherein the spreadsheet format includes row labels indicative of predetermined time increments and column labels indicative of a day of a week.

13. A method for managing a vehicle group, comprising:
recognizing a predetermined trigger via an in-vehicle telematics unit of a vehicle in the group;
in response to the predetermined trigger, transmitting vehicle data from the in-vehicle telematics unit to a call center in selective operative communication with each vehicle in the vehicle fleet; and
automatically populating at least some of the vehicle received at the call center into predetermined cells of a Gregorian calendar associated with an Internet-enabled program in selective communication with the call center, the Gregorian calendar having spreadsheet functionality.

14. The method as defined in claim 13, further comprising generating reports based on the populated vehicle data.

15. The method as defined in claim 13, further comprising at least one of deriving or calculating information from the populated vehicle data.
